(19) United States
(12) Patent Application Publication
(10) Pub. No.: US 2009/0133589 A1
(43) Pub. Date: May 28, 2009

(54) Equipment to break coconuts, nuts, macadamia nuts, and similar, and process to break coconuts, nuts, macadamia nuts and similar

(76) Inventor: Jose Vilani Oliveira, JR., Rio de Janeiro (BR)

Correspondence Address: Christopher J. Fildes;Fildes & Outland P C, 20916 Mack Ave Ste 2, Grosse Pointe Woods, MI, 48236, US

(21) Appl. No.: 11/920,985

(22) PCT Filed: May 26, 2006
(86) PCT No.: PCT/BR2006/000102

§ 371 Date: Nov. 21, 2007

(30) Foreign Application Priority Data
May 27, 2005 (BR) PI5005013-8

(51) Int. Cl. A23N 5/00

(52) U.S. Cl. 99/568; 99/581

(57) ABSTRACT

The present invention has the function of breaking coconuts, nuts, macadamia nuts, an similar by increasing compression using wedge and rolling compression, having pins and fins on the roll surface, it favors less energy consume, more yield, and productivity qualitative gain of the whole macadamia nut (with higher aggregated value) and quantitative utilization of broken coconuts, nuts, macadamia nuts, and similar of 100%, continuous work, installation, maintenance and training costs extremely low, and consequently low final cost of the finished product. The said equipment is constituted of a roll (3) that rotates having on it, conveniently spaced, a cylinder segment (4), being the space existent between them in a wedge shape in such a way that once penetrating in this section, a coconut, nut or similar (10) is compelled to dislocate inside it, rotating and being continuously compressed until the shell rupture, without suffering shock.

The present invention is related to a coconuts, nuts, and macadamia nuts breaker and similar, simple and efficient which causes the break of the coconut shell by increasing pressure, without chock, as well as the process to break the coconuts and nuts.

Presently, the existent equipments to break coconuts, nuts, macadamia nuts and similar use processes that result in a low yield and low productivity, in addition to the high energy demand. The equipment now patented under the number PI9503687-3, here incorporated by reference, presents many advantages over the others, as bigger yield and productivity of nuts and whole almonds, useful coconuts. The useful coconuts, nuts and whole almonds have high aggregate value and, consequently, great demand.

The principle used in continue compression with the objective to maintain the integrity of the element in the interior occurs due to the fact the coconut, nut, macadamia nut or similar penetrates into the camera, made of a cylinder and a roll (it can be cylinder shaped if they are pre-selected or conic), being conducted by the way of rolling attrition to the interior of the camera suffering increasing and enough compression to break coconut, nut, macadamia nut or similar through section narrowing. After the rupture the coconut, nut, macadamia nut or similar falls immediately into the gutter sliding by sloping down to a storage room.

Doing so the inconvenient of triturated or badly broken coconuts end up, once the coconut does not break, it can return to the beginning of operation. It is achieved a greater percentage of nuts and whole almonds, and coconuts broken.

The only inconvenient verified in this process during this production and test period is due to the fact that few coconuts, nuts, macadamia nuts and similar have broken away from the optimal broken point, being necessary reprocessing in the operation line of break or be broken but stay wedged, choked or locked inside the breaker making the coconuts, nuts, macadamia nuts and similar that are being admitted in the equipment to be broken be deviated from the optimal broken point inside the equipment, being reprocessed and diminishing the yield.

Take into account this problems and with the purpose of overcome them it was searched and developed the improvement of the equipment, object of the present invention, which has a fundamental difference and which consists in installing pins and fins through the whole extension of the cylinder put inclined, longitudinal or in a curl way in such a manner to guide to the optimal broken point the coconuts, nuts, macadamia nuts and similar admitted into the equipment and expel out those who have not a complete, regular break or whose shell or coconut stay wedged, choked or locked inside the breaker. With this it is guaranteed that the breaker will be free and clean to continue admission without the risks above cited.

This manner of construction of the breaker solves the inconvenient exposed in its totality, once the coconuts, nuts, macadamia nuts and similar entering the breaker will suffer continuous compression until the shell rupture and through the movement of the rolling leave the breaker. In case of the material stays wedged by partial break or other reason, between the cylinder and the shield, the fins or pins, which must be separated of each other with a distance less than the smaller diameter of the coconuts, macadamia nuts and similar, will carry the material to the exit keeping continuous compression and promoting the break. Another relevant fact is that this new constructive form assures the break of all the pre-selected nuts, macadamia nuts and similar admitted into the equipment, a qualitative gain of productivity of at least 15% of the whole macadamia nuts (with greater aggregate value) and quantitative of at least 10% of coconuts, nuts, macadamia nuts and similar facing the anterior model.

The invention can be better-understood trough the following description according to the drawings appended:

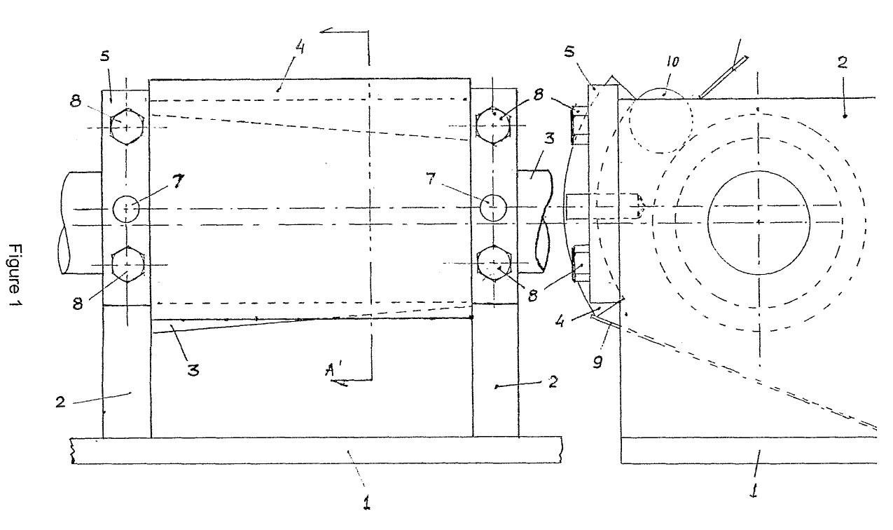

FIG. 1 constitutes a front and lateral view of the equipment to break coconuts, nuts, and macadamia nuts and similar (FIG. 1).

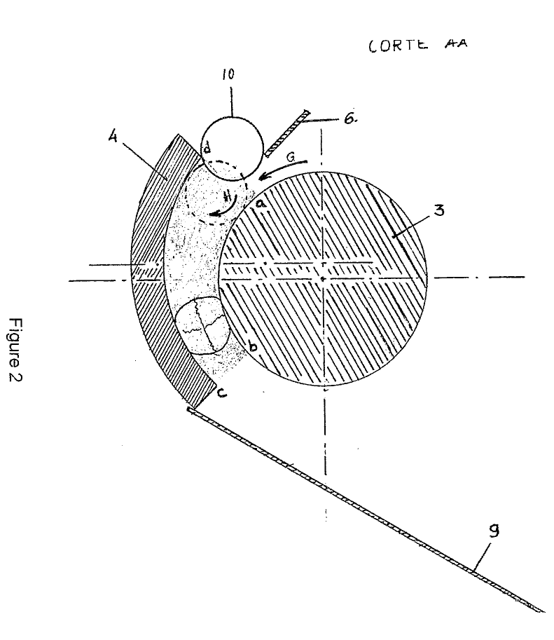

FIG. 2 constitutes a partial AA″ cut view made in FIG. 1 in a front view of the equipment to break coconuts, nuts, macadamia nuts and similar.

Referring to these figures, it can be seen the roll (3), which can be parallel or conic, depending if the coconuts have a pre-selected diameter or not, respectively.

The roll (3) is mounted over bearings existing in (2) which can be started manually or through an electrical or mechanical process. The bearing holders are fixed in the base (1).

Over the bearing holders (2) is conveniently positioned a cylinder section (4), whose center line is delayed in relation to the roll (3) center line and can be dislocated in such a way to allow spacing adjust between them trough screws (8) according to the average diameter of the coconuts, nuts, macadamia nuts and similar to be broken.

The distance between the roll (3) and cylinder section (4) centerlines is kept constant, whichever the performed adjust, and is kept through the guide (7) in the platter (5), which is fixed at (4), allowing the space variation between (3) and (4) without changing them. The pins and fins (11), fixed to the roll (3) rotate with the same roll rotation and have as inferior high the minimum distance between the roll (3) and the cylinder section (4).

The ruler (6) fixed in (2) forms a little canal with the internal superior edge of (4) driving the coconuts coming from a feeder to arrange the entrance of the same to be broken. This ruler must be utilized in conic roll breakers. To parallel roll, the coconuts, almonds, nuts, macadamia nuts and similar must be pre-selected according to size standard, and feed the equipment continuously, with productivity gain.

The pins and fins (11) can be disposed all over the cylinder extension, positioned in an inclined way, delayed, longitudinal or in a curl way in such a way to guide to the optimal broken point the coconuts, nuts, macadamia nuts, and similar admitted by the equipment and expel those whose break was not complete for being stocked, choked or wedged.

The broken fragments are received in the gutter (9) being received through sloping down to a storage room where it will be afterwards separated the shell and the almonds, nuts, macadamia nuts or similar.

In the cut AA′ it is characterized the working principle of the invention. It shows a cut of the roll (3), the pins and fins (11), the cylinder section (4), the coconut guide ruler (8), the gutter (9) and a coconut (10).

Once the coconut penetrates in the camera existent between the roll (3) and the cylinder section (4), it is dragged penetrating into the camera, rotating in the (H) direction via the roll (3) action in (G) direction. The coconut (10) suffers increasing compression due to the section narrowing, as it can be seen, the bc section is smaller than ad, taking the shell to rupture when it trespasses its resistance limit to compression.

After rupture the coconut, nut, macadamia nut, or similar diminishes its size due to the shell break and once being close to the exit in section bc, and due to its own movement, it falls in the gutter (9) where it will go to the separation process of the shell and nut, macadamia nut, almonds, or similar.

Logically, the breaker as well as the pins or fins can be obtained in different sizes and capacities to attend user's needs for this type of equipment.

1. Equipment to break coconuts, nuts, macadamia nuts, and similar constituted by a roll with a rough external surface which rotates having a cylinder segment of rough internal wall, having the center lines conveniently apart in such a way that generates a camera in a wedge shape by narrowing the section, characterized by having pins or fins all over the cylinder extension or by sections, inclined disposed, longitudinal or in a curl way in such a way to guide to the optimal break point of coconuts, nuts, macadamia nuts, and similar admitted in the equipment and expel those that do not have a complete, regular break or whose shell or coconut stays wedged, choked or locked inside the breaker.

2. Equipment to break coconuts, nuts, macadamia nuts, and similar according to the claim 1 characterized by the spacing in a wedge shape between two rough surfaces between the roll and the cylinder segment that compress the coconut, nut, macadamia nut, and similar that penetrates in that until the shell rupture, then obligating the coconut to rotate and penetrate at the same time that the compression on the shell increase due to the surfaces in contact with the same due to the section narrowing, which turns into inferior than the smaller coconut diameter.

3. Equipment to break coconuts, nuts, macadamia nuts, and similar according to claim 1, characterized by having the pins or fins all over the cylinder extension or by sections, disposed in relation to the principal axis, inclined.

4. Equipment to break coconuts, nuts, macadamia nuts, and similar according to claim 1, characterized by having the pins or fins all over the cylinder extension or by sections, disposed in relation to the principal axis, in a curl way.

5. Equipment to break coconuts, nuts, macadamia nuts, and similar according to claim 1, characterized by having the pins or fins all over the cylinder extension or by sections, disposed in relation to the principal axis, longitudinal.

6. Process for breaking coconuts, nuts, macadamia nuts, and similar characterized by the coconut once penetrates the camera formed between the roll and the cylinder section is dragged penetrating into the camera rotating in the direction by the action of the roll rotation in direction. The coconut suffers increasing compression due to the section narrowing once, as can be observed, the section bc is smaller than ad, taking the shell to rupture when it trespasses its resistance limit to compression. After rupture the coconut, nut, macadamia nut, or similar diminishes its size due to the shell break and once being close to the exit in section bc, and due to its own movement, it falls in the gutter where it will go to the separation process of the shell and nut, macadamia nut, almonds, or similar.
